(19) United States
(12) Patent Application Publication
(10) Pub. No.: US 2006/0103638 A1
(43) Pub. Date: May 18, 2006

(54) Light film device

(76) Inventor: George O. Podd, Lake Forest, IL (US)

Correspondence Address: Douglas H. Pauley;Pauley Petersen & Erickson, Suite 365, 2800 West Higgins Road, Hoffman Estates, IL, 60195, US

(21) Appl. No.: 11/259,909

(22) Filed: Oct. 27, 2005

Related U.S. Application Data
(60) Provisional application No. 60/623,754, filed on Oct. 29, 2004.
(60) Provisional application No. 60/724,476, filed on Oct. 7, 2005.

(51) Int. Cl. G09G 5/00

(52) U.S. Cl. 345/204

(57) ABSTRACT

A light film apparatus that can be used to display static any/or dynamic graphics on an illuminated graphics panel. The illuminated graphics panel can be mounted in or near a window of a vehicle, a building or the like. Any one or more sensors can detect a condition and communicate a sensed signal to a control module. The control module processes each sensed signal and emits one or more output signals, as a function of each sensed signal, to operate the illuminated graphics panel. The illuminated graphics panel can be an electroluminescent display device. A light film apparatus of this invention can be easily installed into any suitable environment. The different sensors and the particular programming can be used to provide a user-friendly device that efficiently manages power required to drive the light film apparatus.

### BACKGROUND OF THE INVENTION

1. Field of the Invention

This invention relates generally to a light film device, particularly an illuminated graphics panel that can be positioned on or near a window or glass surface, such as on a vehicle.

2. Discussion of Related Art

Electroluminescent lamps or devices have been used for signage. There are known methods for manufacturing EL lamps or devices.

One conventional emergency exit sign uses an EL lamp in combination with a pilot light which is connected to the EL lamp by way of a photoelectric link. The photoelectric link monitors the brightness of the EL lamp and keeps on the pilot light as long as the EL lamp is lit. Illumination provided by the EL lamp may be less than the illumination of background brightness, making it difficult to tell by looking at the EL lamp whether or not the EL lamp is energized. Thus, the pilot light provides a point of illumination that can be easier to detect than whether the EL lamp is lit. This particular combination can be useful for building inspectors that check the operational status of an exit sign.

### SUMMARY OF THE INVENTION

There is a need to enhance visibility of graphic elements in different places, for many safety reasons and marketable applications. For example, enhanced visibility of graphic elements on vehicles may help overcome low visibility driving conditions, such as snow, rain, darkness and/or fog. With increased visibility of specific graphic elements on a vehicle, other motorists can better see dedicated information, particularly in adverse weather conditions or low visibility driving conditions. The light film device of this invention can be used in any suitable or desirable situation or format, such as a safety signal, a public service symbol including symbols of the Department of Transportation, the Military, the National Guard, the Police and the Fire Departments, a construction sign, a zone authority, a help/warning message, and many other marketable applications, including zone parking passes for major events, promotional icons, vehicle brand logos and advertising messages.

There is also a need for a product according to this invention, to address and satisfy specific criteria for practical or real world use. In one embodiment of this invention, this is achieved by integrating illuminated graphic panels with sensors, a dim switch or sensor and a control module, which can be programmed and/or assembled to operate within specific parameters of a dedicated driving or usage environment.

A light film device according to embodiments of this invention can include an electroluminescent (EL) panel integrated or combined with a translucent graphics panel, a light sensor, a motion sensor, a time sensor and/or dim settings. The light film device can be mounted to a structure or surface, such as a vehicle window or a building window, to allow theme graphics, such as words, logos and/or symbols, to be highly visible, for example during low visibility weather and/or driving conditions.

There is a need to provide specific operating criteria, in certain situations. Issues should be addressed for real world or marketplace product applications.

In some instances, product according to this invention, when introduced into the marketplace, should conform to local regulations, such as a variety of U.S. Federal and U.S. State transportation regulations regarding lumen output levels, animation effects and product positioning or placement on a vehicle. A dim switch or control feature may allow a lumen output level to be adjusted to within or to not exceed one or more set regulations. This feature or adjustment can occur manually or automatically. A mode switch feature can ensure that a final use falls within or meets regulations. The product configuration may allow mounting on a side window or a back window of a vehicle, for example, depending on an intended use.

A product of this invention may be easy to use, require low maintenance and operate within control module settings and functional parameters. For example, a motion sensor, a light sensor and/or a timer switch can be used to make all necessary or desired adjustments, so that the user does not have to use or address the on/off switch once a desired operational mode is set. The user may have an option to change a mode setting. A battery recharge capability, particularly if automatic, allows the user to not be concerned with replacing or manually recharging batteries. A removable battery module provides a simple battery replacement operation. A flexible mounting adaptation and a DC adaptor with a control module allows easy installation. A battery pack does not require auto wiring operation for easier installation.

A product according to this invention can be manufactured and operate within a range of reasonable costs, based on potential market applications. An interchangeable translucent graphic panel and layer assembly allows the EL component to be standardized as white backlight. Thus, custom printing of clear plastic sheet material minimizes the cost, the inventory and the production time. Sensors optimize product function, provide a user-friendly product and prolong battery life during use. There can be a battery recharge capability with, for example a solar panel option, to prolong battery life. A vehicle DC port and adapter/control module allows use of the device without batteries.

With a product according to this invention, consumers may obtain value added attributes of increased visibility for their specific needs. Also, the consumer is able to use the light film device of this invention, if necessary within legal vehicle guidelines, and benefit from improved user features and cost effective operation. The light film device of this invention can include a static or constant display or illumination and/or a dynamic or animated graphic display or illumination, and can also include two or more graphics panels. The light film device of this invention can be used for any suitable application other than vehicular applications, such as for signage in a home window or in a business or store-front window.

### BRIEF DESCRIPTION OF THE DRAWINGS

Features of this invention can be better understood when this specification is read in view of the drawings, wherein:

FIG. 1 is a perspective front view of a light film device having a graphic display area and a light sensor location, according to one embodiment of this invention;

FIG. 2 is a perspective rear view of the light film device as shown in FIG. 1, including solar panels and a removable battery module;

FIG. 3 is an exploded perspective rear view of a light film device, according to one embodiment of this invention;

FIG. 4 is a rear view of the light film device, as shown in FIG. 3;

FIG. 5 is a top view of the light film device, as shown in FIG. 3;

FIG. 6 is a bottom view of the light film device, as shown in FIG. 3;

FIG. 7 is a side view of the light film device, as shown in FIG. 3;

FIG. 8 is a front view of a light film device, according to another embodiment of this invention;

FIG. 9 is a rear view of the light film device, as shown in FIG. 8;

FIG. 10 is a side view of the light film device, as shown in FIG. 8;

FIG. 11 is a front view of a light film device, according to another embodiment of this invention;

FIG. 12 is a rear view of the light film device, as shown in FIG. 11, operatively connected to a solar panel;

FIG. 13 is a side view of the light film device, as shown in FIG. 11;

FIG. 14 is a sectional view of the light film device of FIG. 4, taken along section line A-A shown in FIG. 4;

FIG. 15 is a sectional view of the light film device of FIG. 4, taken along section line B-B shown in FIG. 4;

FIG. 16 is a sectional view of the light film device of FIG. 4, taken along section line C-C shown in FIG. 4;

FIG. 17 is a perspective view of a light film device mounted to a vehicle window, according to one embodiment of this invention;

FIG. 18 is a perspective view of a light film device, including a battery pack and a solar panel, according to another embodiment of this invention;

FIG. 19 is a perspective view of a light film device, showing two versions of an adapter plug, according to another embodiment of this invention;

FIG. 20 is a front view of a light film device, according to another embodiment of this invention;

FIG. 21 is a rear view of the light film device, as shown in FIG. 20;

FIG. 22 is a front view of a solar panel, according to one embodiment of this invention;

FIG. 23 is a side view of the solar panel, as shown in FIG. 22;

FIG. 24 is a rear view of the solar panel, as shown in FIG. 22;

FIG. 25 is a flow chart showing program steps of light and motion control, according to one embodiment of this invention;

FIG. 26 is a flow chart showing program steps for light, motion and wireless control, according to one embodiment of this invention;

FIG. 27 is a flow chart showing program steps for light, motion and sound control, according to one embodiment of this invention;

FIG. 28 is a flow chart showing program steps for light and acceleration control, according to one embodiment of this invention; and

FIG. 29 is a flow chart showing program steps for light and dual acceleration control, according to one embodiment of this invention.

### DESCRIPTION OF THE INVENTION

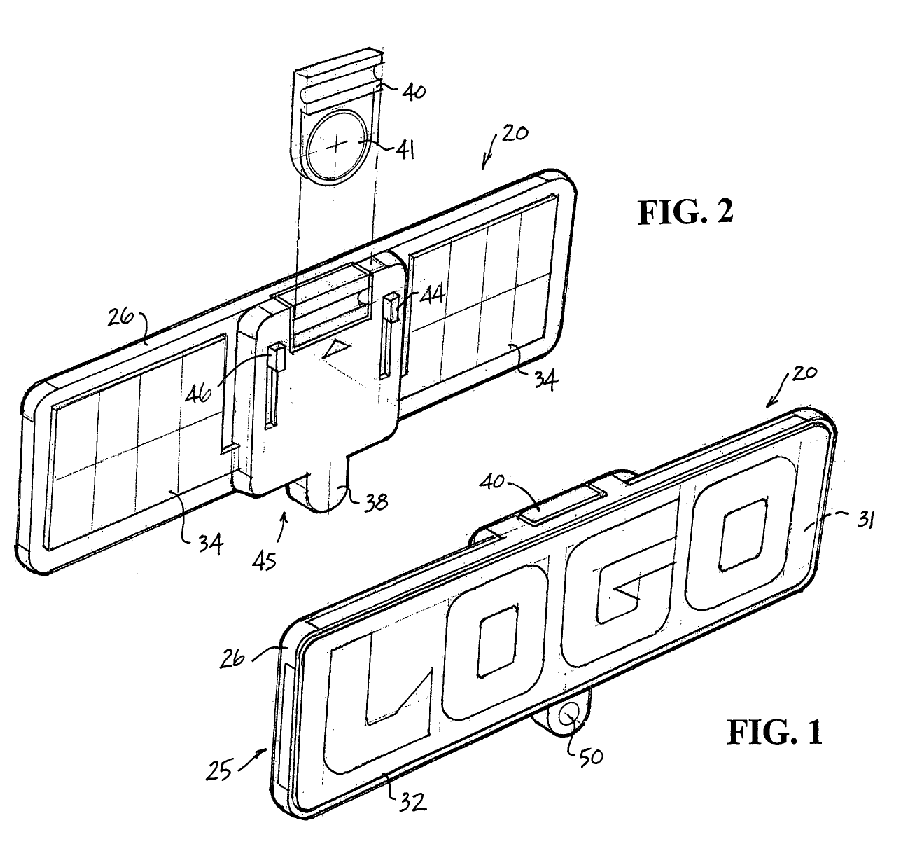

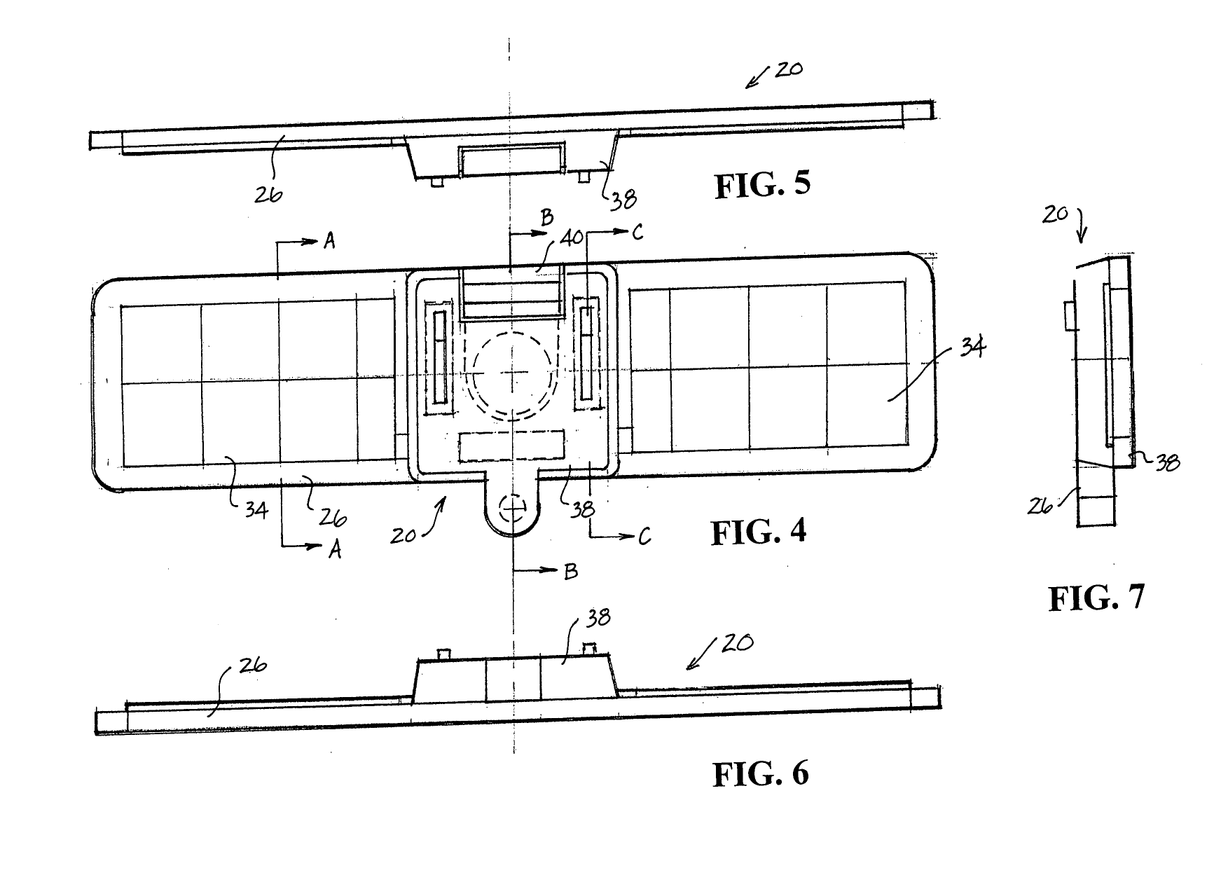

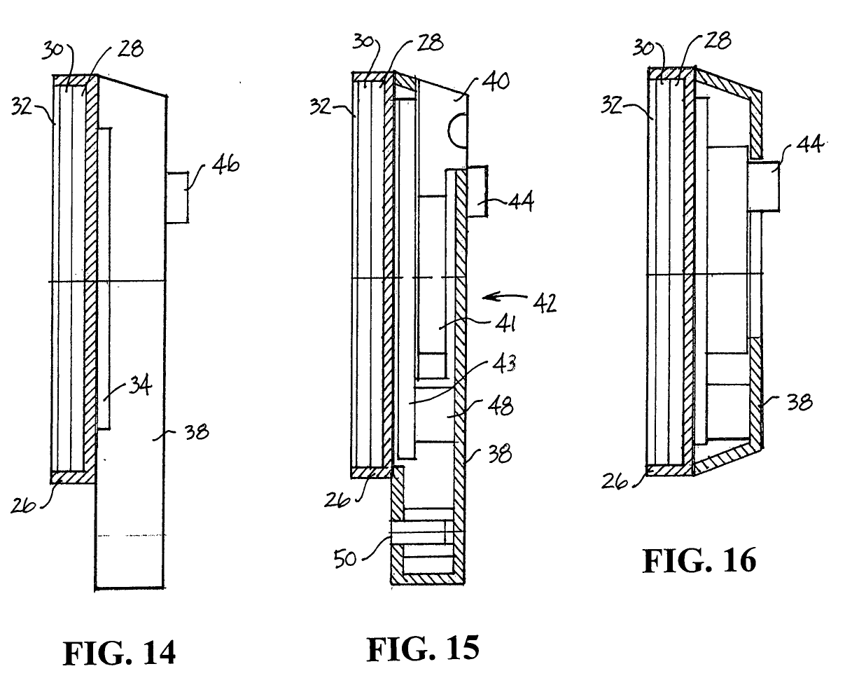

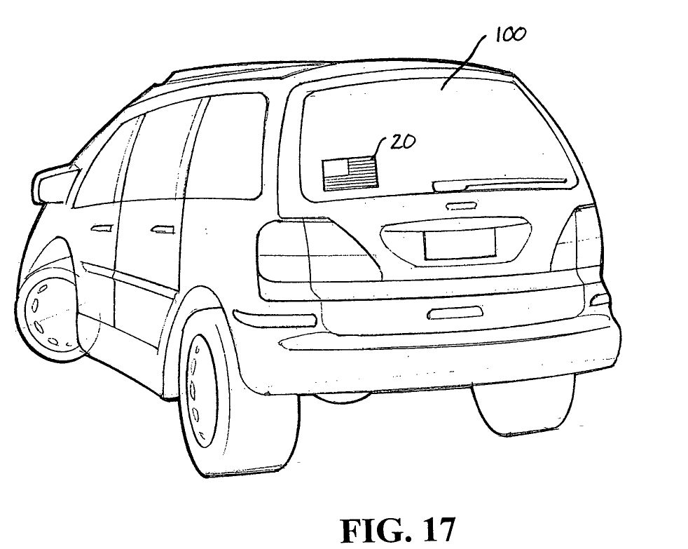

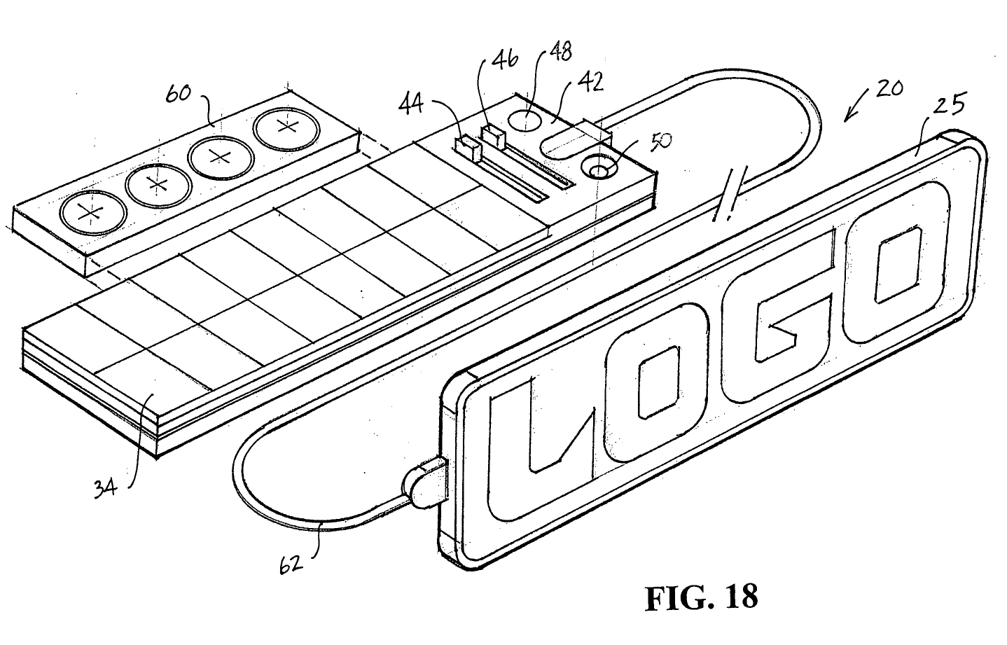

This invention provides a light film device including a light film component, a control module and in certain embodiments a solar power unit and/or a battery. FIGS. 1-19 show a light film device, according to certain embodiments of this invention. The light film device can be mounted with respect to a window, such as vehicle window 100 shown in FIG. 17, to display desired graphics for marketing applications, safety applications and/or emergency situations, for example. The light film device of this invention can provide highly visible graphics that other motorists and/or pedestrians or bystanders will be able to see in adverse weather conditions and/or adverse driving conditions, for example. The light film device of this invention can be used for a variety of applications including, but not limited to, safety signals, public service symbols, such as the Department of Transportation, the Military, the National Guard, the Police and the Fire Department logos or plaques, construction locations and workers, zone authorities, help/warning messages, and other suitable informational and/or marketable applications, such as zone parking passes for major events, promotional icons, vehicle brand logos and advertising messages.

Throughout this specification and in the claims, the phrase illuminated graphics panel, the phrase electroluminescent display device, the phrase electroluminescent display, the phrase electroluminescent device and the phrase electroluminescent element, the phrase light emitting diode (LED), as well as other similar phrases, are intended to be interchangeable with each other. The phrase illuminated graphics panel or any of the other interchangeable phrases each is intended to relate to a lighting device that includes panel shaped elements which can be lit by any suitable light supply or source. The phrase illuminated graphics panel and the interchangeable phrases are also intended to relate to and include currently available EL lighting devices, as well as EL devices or other suitable lighting devices that may become available.

In certain embodiments of this invention, the illuminated graphics panel may be designed and/or manufactured with light emitting diode (LED) technology, which can provide cost savings. For example, it may be possible to diffuse LED lights into dedicated panel segments, which can have any suitable dimensions, cross section and or/or shape.

In one embodiment of this invention, a pocket approach or arrangement can use molded plastic opaque walls, when viewed from a top direction to see a shape of particular artwork segments that can partition off LED lighted segments, such as with walls or structural baffles. An LED structure can be mounted on or to a board, such as wired, soldered or otherwise electrically connected to a PC board, and positioned near, for example beneath each segment. The LED structure can be pressed into a pocketed light diffuser, for example a clear etched plastic, in a desired shape of the segment.

In another embodiment according to this invention, to accomplish an evenly distributed lighting, segments of the wall structure can be molded into different shapes, such as art shapes. The segment shapes can be injection molded plastic, for example, with or without etching to provide a textured outer surface which can but need not be back painted with a white or non-white paint or other similar material. LED structures can be mounted or positioned adjacent or near an edge of the segment, to distribute light into the segment. Edge lighting can help implement different intricate or complex graphic designs.

When the illuminated graphics panel of this invention is constructed with LED structures, the overall dimensions will typically be greater than a similar product manufactured with one or more EL elements 28. The LED structure requires increased segment material to more evenly distribute light for each graphic segment, which can result in added thickness of the panel to achieve better light distribution, depending upon the particular use. However, if costs associated with the LED technology are or become low enough, there can be a significant market demand for the LED technology.

In one embodiment of this invention, such as shown in FIGS. 1-7, light film device 20 comprises light film component 25. Light film component 25 comprises frame or housing 26 for mounting or containing housing elements of light film component 25. Housing 26 can have any suitable shape and/or size to properly house one or more elements of light film component 25. An electroluminescent (EL) element 28, a translucent element 30 and an adhesion element 32 are positioned, arranged or configured in a layered, sandwiched or surface-to-surface relationship and are securely housed within and/or connected to housing 26, according to embodiments similar to that as shown in FIGS. 1-3. Preferably but not necessarily, each element surface or another suitable portion of each element is positioned with respect to a surface or another suitable portion of an adjacent element of light film component 25. For example, elements of light film component 25 can be in surface-to-surface contact with adjacent or nearby elements of light film component 25. An interchangeable panel, such as a tinted translucent panel, can be positioned to mount between EL element 28 and the surface to which housing 26 is mounted, such as window 100. An interchangeable translucent graphic panel having a layered assembly allows EL element 28 to be standardized, for example as white backlight, and thus custom printing on clear plastic sheet material can be used to reduce costs, inventory and/or production time.

In certain embodiments of this invention, the elements of light film device 20 can have any suitable overall and/or cross-sectional shape and/or can be configured in any suitable relationship. It is possible to provide a layered configuration wherein each element layer is laminated, such as during manufacture or construction, to preferably but not necessarily produce an apparatus or device having a relatively slim design. It is also possible to provide a backer plate configuration, wherein elements are integrated with, affixed to and/or connected to a backer plate, such as an injection molded backer plate. It is also possible to provide a backer housing configuration, wherein elements are integrated with, affixed to and/or connected to a module, such as an injection molded module. In each configuration, subassemblies can be mounted at any suitable location to dedicated or available surfaces, including any suitable vehicle surface.

EL element 28 of this invention may comprise any suitable conventional EL element available in the marketplace. In one embodiment of this invention, EL element 28 comprises at least one panel. For example, EL element 28 may include at least one white color or non-color panel that extends along at least a portion of a front surface or area of housing 26. EL element 28 can comprise other color panels in addition to or in lieu of the at least one white color or non-color panel, any of which is suitable to back light graphics panel 31. Preferably but not necessarily, EL element 28 covers all or substantially an entire area of the front surface or area of housing 26. In certain embodiments of this invention, EL element 28 can be produced or printed with any suitable graphic, which may eliminate the need for element 30.

In certain embodiments of this invention, EL element 28 can have a plurality of segments, each of which can be individually controlled. Control module 42 can emit an output signal to any one or more of the different segments of the EL element 28. With the independent control of each segment, many different complex static or dynamic graphics can be displayed with light film device 20 of this invention.

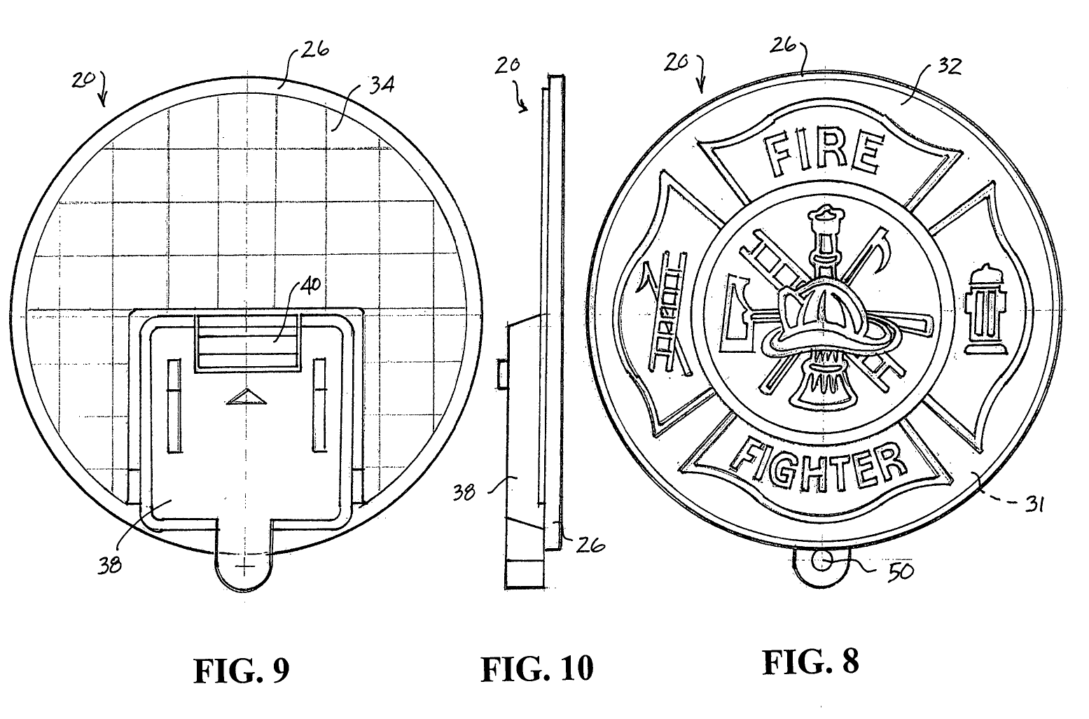

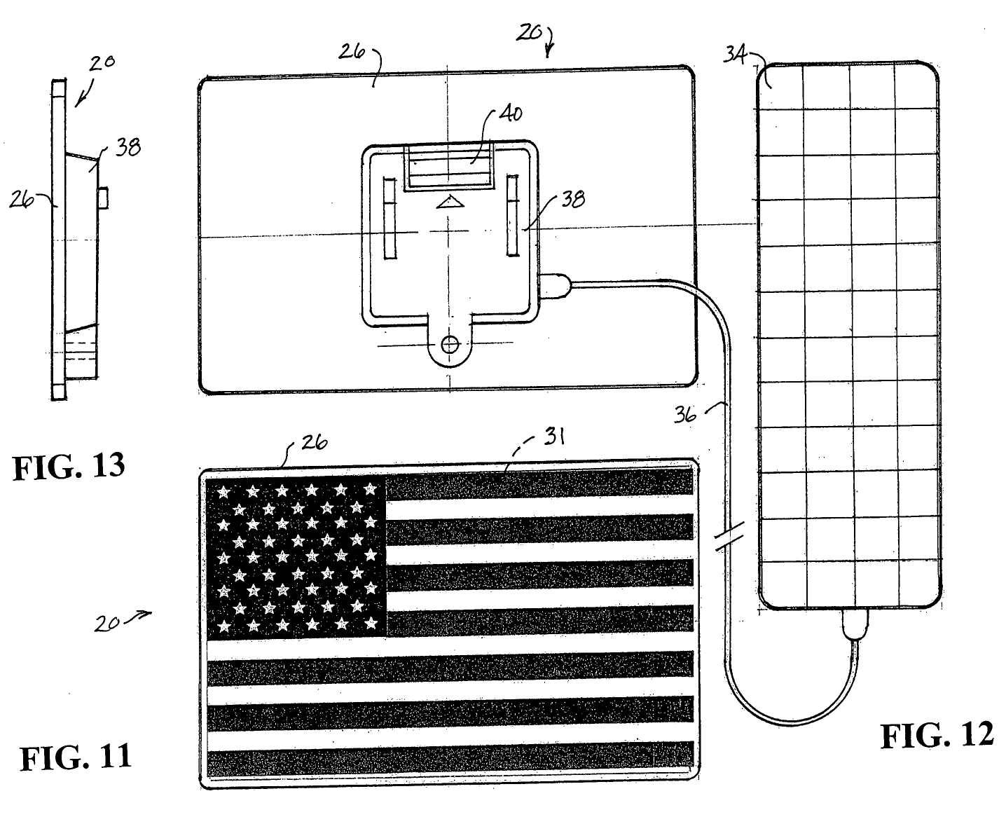

As shown in FIG. 3, element 30 may or may not be translucent and is positioned in a relatively fixed relationship with respect to EL element 28. For example, a first surface of element 30 preferably contacts an adjacent surface of EL element 28. Element 30 may comprise a suitable or desirable graphics panel 31, such as shown in FIGS. 1 and 8. Graphics panel 31 can include any desirable graphic, such as a logo as shown in FIG. 1, a fire department plaque as shown in FIG. 8 or an American flag as shown in FIG. 11, for example. Those skilled in the art will understand that element 30 can include graphics panel 31 having any desirable or suitable dimensions, cross section and/or shape. Graphics panel 31 can have any desirable number and/or configuration of graphic displays. Element 30 and/or graphics panel 31 can include any suitable film material, such as an acetate film layer, a LEXAN film layer or any other suitable clear sheet material. Preferably but not necessarily, element 30 and/or graphics panel 31 each is printed with a translucent ink, such as CMYK ink or a spot color inks.

Adhesion element 32 comprises one surface that contacts another surface of element 30, for example as suggested by FIG. 3. Adhesion element 32 includes a surface that contacts a support or mounting surface, such as a business front window, a door window or a vehicle window. Adhesion element 32 can be of any suitable clear or translucent adhesive, such as in a layer form. Adhesion element 32 may include a suitable adhesive component or layer to removably secure light film device 20 to the mounting surface so that light film device 20 is securely mounted to the mounting surface when in use, but can be selectively removed from the mounting surface without damage to adhesion element 32 and/or the mounting surface. Other suitable components, such as suction cups, brackets, other adhesives, static cling devices, screws, wire, hook-and-loop fasteners and/or any other mechanical, electrical and/or magnetic connector can be used to mount light film device 20 with respect to a mounting structure or surface.

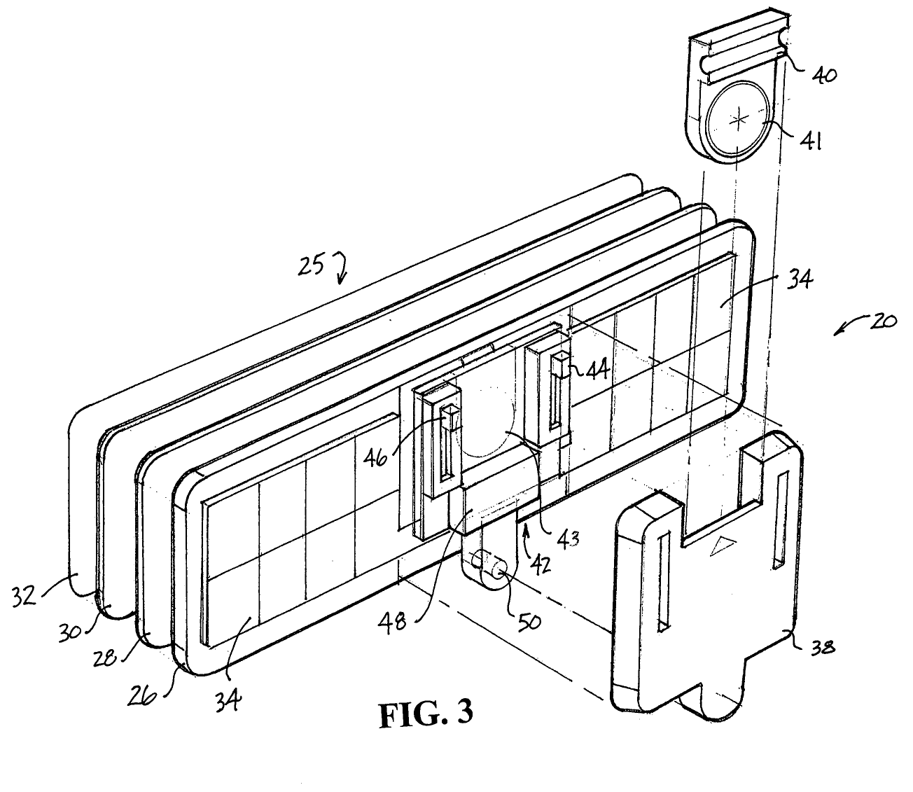

In one embodiment of this invention, at least one solar panel 34 is operatively connected, electrically and/or mechanically, to light film component 25, for example to provide backup power and/or recharge power to a battery operated or DC powered light film device 20. Solar panel 34 can be integrated with light film component 25, can be connected to light film component 25, such as to a back surface of housing 26 as shown in FIGS. 2 and 3, and/or can be an independent component tethered to light film component 25 via a wire or cable connection 36, such as shown in FIG. 12. Preferably but not necessarily, solar panel 34 is positioned, mounted or located with respect to any suitable structural component of a vehicle, for example to optimize absorption of solar power.

In certain embodiments of this invention, solar panel 34 can be structurally, mechanically and/or electrically connected to or integrated with housing 26 so that the solar collectors rotate and/or pivot with respect to each other and/or housing 26, for example to take advantage of any moving solar energy source. Any suitable servomotor control, structural and/or electrical connection can be used to accomplish any suitable relative movement. Single or multiple solar panels 34 can be used to accomplish different physical arrangements. When light film device 20 of this invention is used in a vehicle, the moveable solar panels 34 can be programmed to manually and/or automatically move to take advantage of a solar energy source and/or to at least partially conceal solar panel 34.

Light film device 20 may comprise battery module 40 positionable or mountable with respect to housing 26 of light film component 25. In one embodiment of this invention, battery module 40 is slidably positionable between module housing 38 and light film component housing 26, such as shown in FIGS. 2-4. Battery module 40 houses a suitable battery 41, such as a lithium cell, Ni-cad rechargeable button cell or standard AAA battery, which powers control module 42. Alternatively, control module 42 can be powered by DC power via power ports located within a vehicle, or even by another suitable voltage. In one embodiment of this invention, solar panel 34 is connected to battery 41 to recharge battery 41, as necessary.

As used throughout this specification and in the claims, the phrase control module is intended to be interchangeable with the phrase control device, the phrase controller, the phrase smart module and/or any other similar phrase that describes a programmed apparatus that controls one or more functions.

In one embodiment of this invention, control module 42 is in communication with a programmed controller, such as PC board 43, which can be mounted in a relatively fixed position with respect to light film device 20. Control module 42, PC board 43 and/or another suitable control element can control or can be programmed to control the operation and management of light film device 20. Preferably, as shown in FIG. 3, at least one of a plurality of components, such as a mode switch or sensor 44, a dim switch or sensor 46, a motion switch or sensor 48 and a light switch or sensor 50, each is operatively connected to and in responsive communication with PC board 43 and/or control module 42 to operate and/or manage an output of light film device 20. Any one or more of the switches or sensors can be hard wired to control module 42 and/or can communicate in a wireless mode with control module 42. At least one of the mentioned sensors, or another suitable sensor, can each emit a sensed signal. In one embodiment of this invention, control module 42 receives the sensed signal and emits an output signal as a function of the sensed signal, to operate EL element 28 or another suitable illuminated graphics panel.

In certain embodiments of this invention, light film device 20 may include any number of the components discussed in this specification, in addition to other suitable or interchangeable components known to those skilled in the art. Mode switch 44 can comprise a multiple position switch including an off position, a motion-on position, a motion-off position, and/or a constant operation position. Mode switch 44 can be used to select a position that operates light film device 20 within any necessary regulation or limited parameter. Dim switch or sensor 46 can include settings to adjust a lumens output level, as desired, for example to conform to any local ordinance, such as vehicle regulations within a particular jurisdiction. Motion sensor 48 can comprise any suitable sensor, such as a spring-type sensor, a rocker-type sensor, an accelerometer, a speedometer, a directional sensor and/or a position sensor. Light sensor 50 preferably communicates with control module 42 to provide appropriate power for proper operation of light film device 20, depending upon the time of day and/or weather conditions, such as darkness, cloudiness, rain, snow and/or fog.

Control module 42 can be interfaced with any suitable position identifying device, such as a Global Positioning System device. As used throughout this specification and in the claims, the phrase position identifying device is intended to be interchangeable with the phrase Global Positioning System device, and is also intended to be interchangeable with any other suitable mechanical and/or electrical device that identifies a position or location of light film device 20 according to this invention. In certain embodiments of this invention, control module 42 can be programmed to adjust any controllable parameter of light film device 20, such as a lumens output level. With such adjustment capabilities, light film device 20 of this invention can be used to manually or automatically identify a position and conform to local ordinances or regulations. Some local areas may require a minimum and/or a maximum lumens output level, which control module 42 can identify and deliver as an output signal to any controllable component of light film device 20. In addition, if any local area prohibits use of light film device 20 according to this invention, control module 42 can be programmed to automatically shut down or turn off light film device 20.

In certain embodiments of this invention, control module 42 can evaluate each sensed signal, process each sensed signal according to programmed steps, and then emit one or more output signals, each of which can include information, for example information to set a power rate at zero, partial power or full power.

In one embodiment of this invention, an internal timer switch can work or cooperate with motion switch 48 and activate at least one illumination switch to an on position, an off position or a partially powered position, after a determined time period has passed, for example a five (5) minute time period, based on a manual and/or an automatic mode determination and setting. Light film device 20 can also include a sound or noise sensor, a vibration sensor and/or a temperature sensor or switch. Additionally, various movement sensors can activate or trigger any one or more of programmed static and/or dynamic graphic animations.

As shown in FIG. 18, light film device 20 according to one embodiment of this invention comprises an independent or detachable control module 42, including mode switch or sensor 44, dim switch or sensor 46, motion switch or sensor 48 and light switch or sensor 50. A removable battery pack 60 and/or solar cell 34 can be connected via a connector, such as wire or cable 62 to light film component 25.

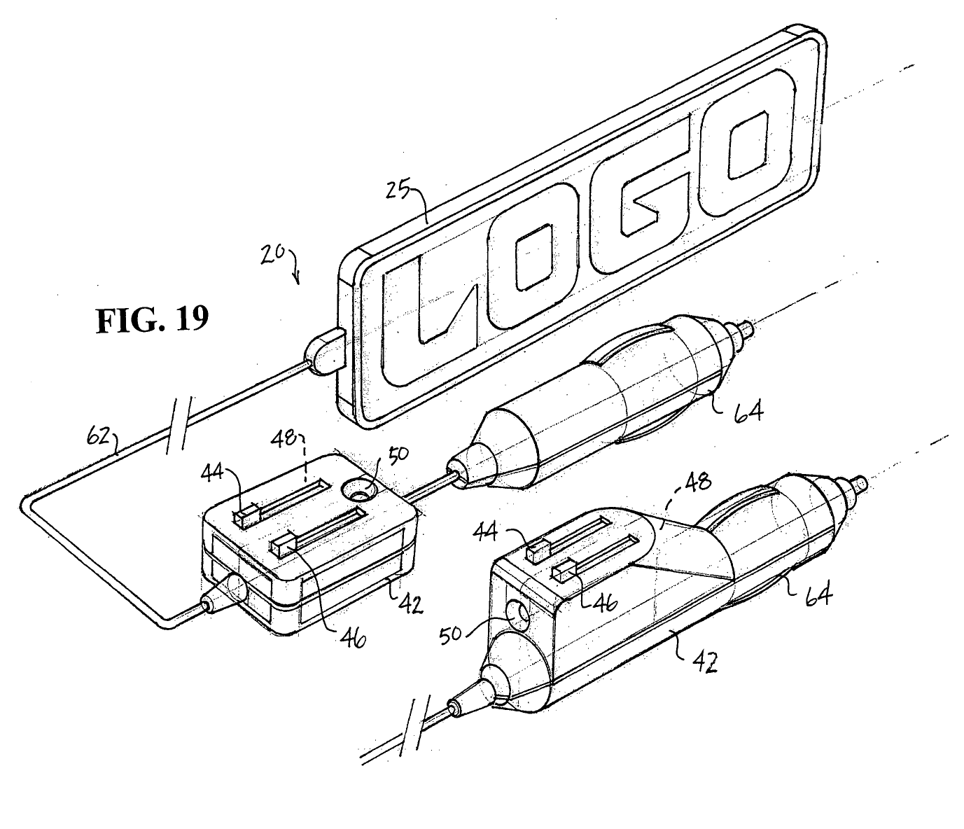

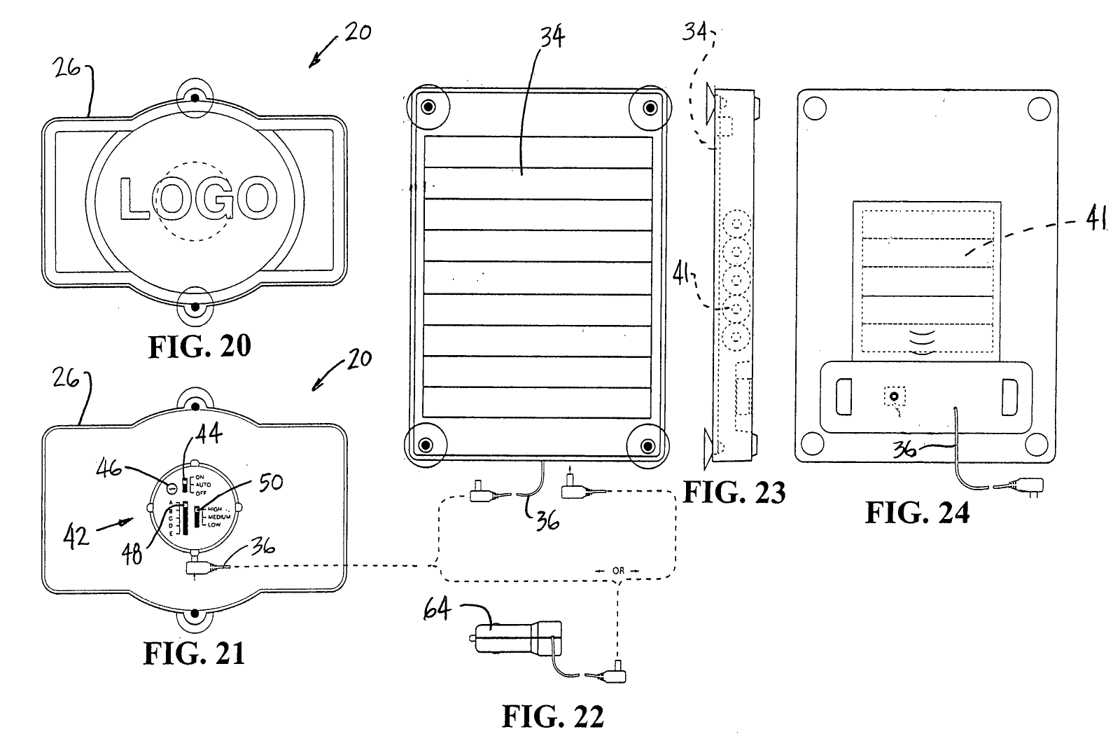

As shown in FIG. 19, light film device 20 according to preferred embodiments of this invention can comprise an independent or detachable control module 42, including mode switch or sensor 44, dim switch or sensor 46, motion switch or sensor 48 and/or light switch or sensor 50, connected to or integrated with plug housing 64, for example to deliver any suitable DC or other power. In one embodiment of this invention, control module 42 can be connected in-line with wire 62, as shown in FIG. 19. The sensors and/or switches of this invention can be used to prolong battery life.

Light film device 20, according to this invention, can produce illuminated graphics, such as those that operate and function in a parameter controlled environment. An illuminated graphics panel can function within parameters defined by control module 42. EL element 28 can be an EL lighted graphics panel that functions within specific parameters, such as those defined by local ordinances or rules, by using different types of sensors and/or switches to feed input information to control module 42, which can be programmed to operate and/or manage a particular environment.

Light film device 20 of this invention can provide illuminated graphics, particularly those which operate in a user-friendly parameter controlled environment. Parameters necessary for a specific controlled environment can be met by suitably programming control module 42 to automatically, with or without a manual input, operate and/or manage the controlled environment.

Light film device 20 can be constructed to achieve specifically desired illuminated graphics in an user-friendly manner, the extent to which can be a function of the programming of control module 42. In certain embodiments of this invention, light film device 20 requires relatively little user input and can be used to achieve the display of critical information, such as safety and hazzard information, as well as non-critical information, such as identifying membership in an organization or providing a graphic message. As an example of an non-critical function, housing 26 can be mounted in a rear window of a vehicle and a soccer ball can graphically move from left to right when the vehicle makes a left hand turn, or from right to left when the vehicle makes a right hand turn. Other similar non-critical messages can be communicated with light film device 20 of this invention.

Control module 42 and/or EL element 28 can be powered using a solar power cell alone or in combination with a battery power source. The solar power source can be used to automatically and/or manually recharge the battery power source. The solar power source can be part of or separate from housing 26. If separated from housing 26, the solar power source can be positioned at a different location, for example in a vehicle to optimize collection of solar rays.

Dim switch or sensor 46 can be used to automatically adjust a lumens output level in order to conform to any particular local regulations. Control module 42 can either calculate a position of light film device 20 and match the position with a stored library of lumens output level settings, for example to comply with a local ordinance, or can accommodate a manual input entry such as a zip code, to match in the stored or programmed library of values.

Light switch or sensor 50 can be used to detect the level of darkness in any particular environment and either automatically power light film device 20 or send a signal that alerts the user to power on light film device 20. Light switch or sensor 50 can be used in combination with dim switch or sensor 46 to adjust the lumens output level of light film device 20, as a function of the detected environmental conditions.

A timer can also be used in combination with motion switch or sensor 48, for example to switch on or off light film device 20, based on a particular mode setting. For example, control module 42 can be programmed to shut down power or go into a standby mode within a certain amount of time after a motion of a vehicle is no longer detected.

Any one or more of the sensors or switches of this invention can be used to send a signal to control module 42 that processes the one or more signals into a particular output signal that displays a particular graphic on EL element 28. For example, any sound, motion, temperature difference or other similar physical parameter can be processed through control module 42, to result in a graphic illustration. For example, stepping on an accelerator can result in a graphical display of a dynamic exhaust flame.

Any suitable integrated circuit board, either with or without one or more integrated circuit chips can be used in combination with or in addition to control module 42 to accomplish different programming capabilities for any input and/or output device.

Adhesion layer 32 can be of any suitable adhesive, either clear or colored, which is suitable to mount housing 26 and the associated elements with respect to a window or other suitable structure. EL element 28 can have any white or non-white color and may also comprise a back light theme graphics panel. EL element 28 may include multiple colored EL panels.

Housing 26 can be assembled in any suitable manner and can be mounted with respect to any suitable surface, including a vehicle surface.

Control module 42 may be locally mounted to housing 26 or can also be at a remote location, with wire or wireless communications to any device being controlled and/or sensed.

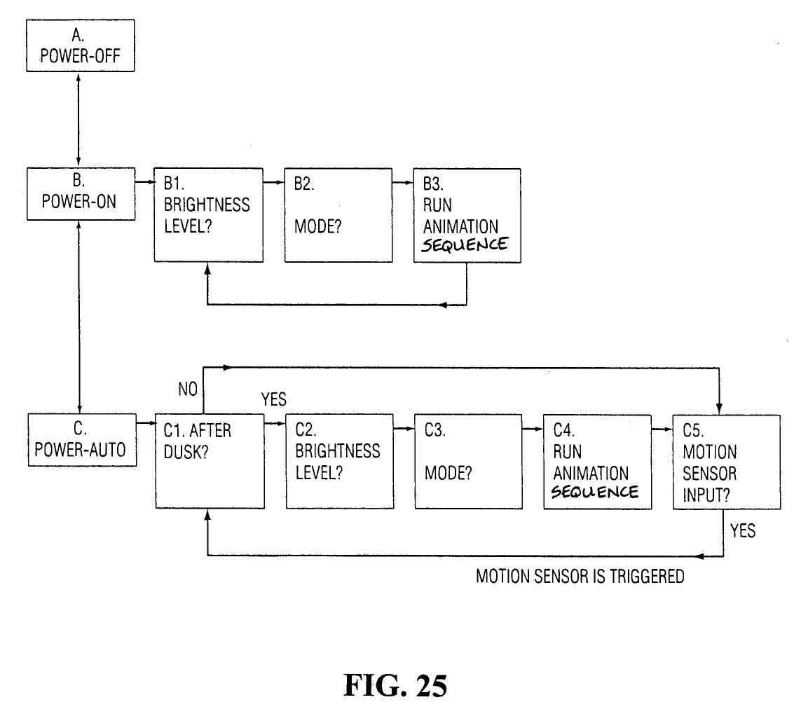

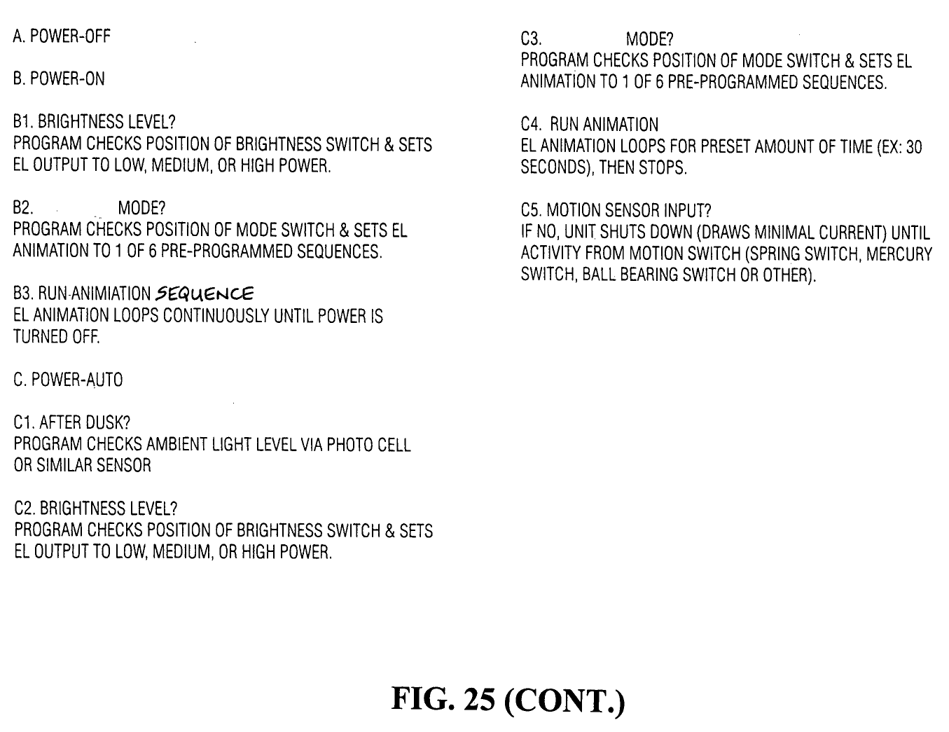

FIGS. 25-29 each shows a different flow chart of programmed steps for accomplishing different control modes, according to this invention. As shown in FIG. 25, EL element 28 can be activated in response to a signal received from motion switch or sensor 48. In the power-on setting, the program can check the brightness level, as set manually or automatically, for example to a level of low, medium or high power. In the power-on setting, the program then checks a position of mode switch or sensor 44. If the conditions are met, then EL element 28 displays graphics until the power is turned off.

As shown in FIG. 25, in the power-auto position, for light control, the program checks the signal received by light switch or sensor 50 and depending upon the position of mode switch or sensor 44, can run the graphics display either for a timed period or until activity is detected from motion switch or sensor 48.

According to the control shown in FIG. 25, light switch or sensor 50 can automatically shut down power when an ambient light level is greater than the light level of EL element 28, for example to conserve power. The user can select one or more animation sequences programmed for delivery to EL element 28, for example by using a slide switch, such as shown in FIG. 21. FIG. 21 also shows a manual switch for selecting one of a plurality of preset levels, shown as low, medium and high, for the lumens output level.

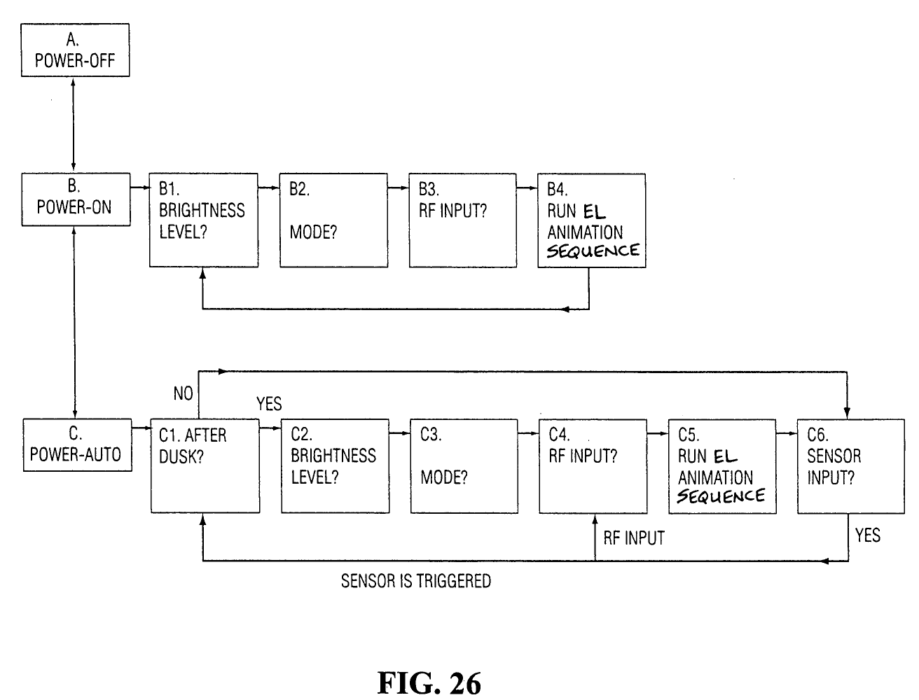

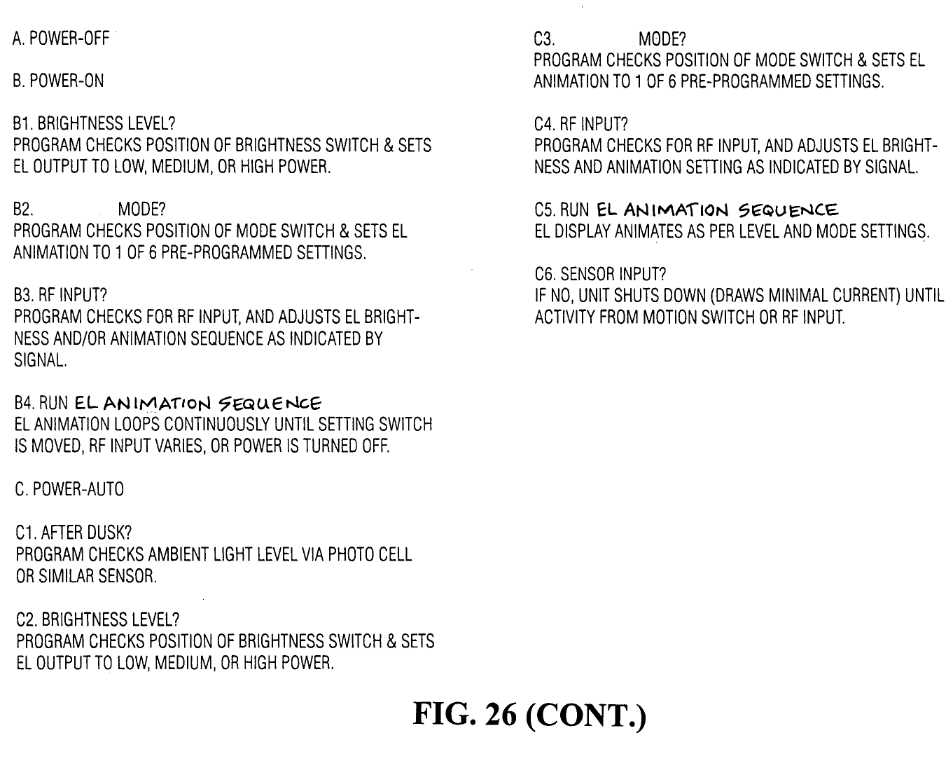

FIG. 26 shows another control scheme which includes a check for a wireless communication, such as a radio frequency (RF) signal. In addition to the program steps shown in FIG. 26, EL element 28 can be activated by a RF signal or by another informational signal, such as from a GPS satellite or a civil communications tower. In one embodiment of this invention, any lumens output level previously set can be overridden and/or replaced through another communication source, such as another RF input, or another GPS satellite input, or another suitable input signal. For example, an oncoming emergency vehicle can emit a signal that overrides and/or replaces the control function in order to display a warning signal to the driver or another nearby motorist.

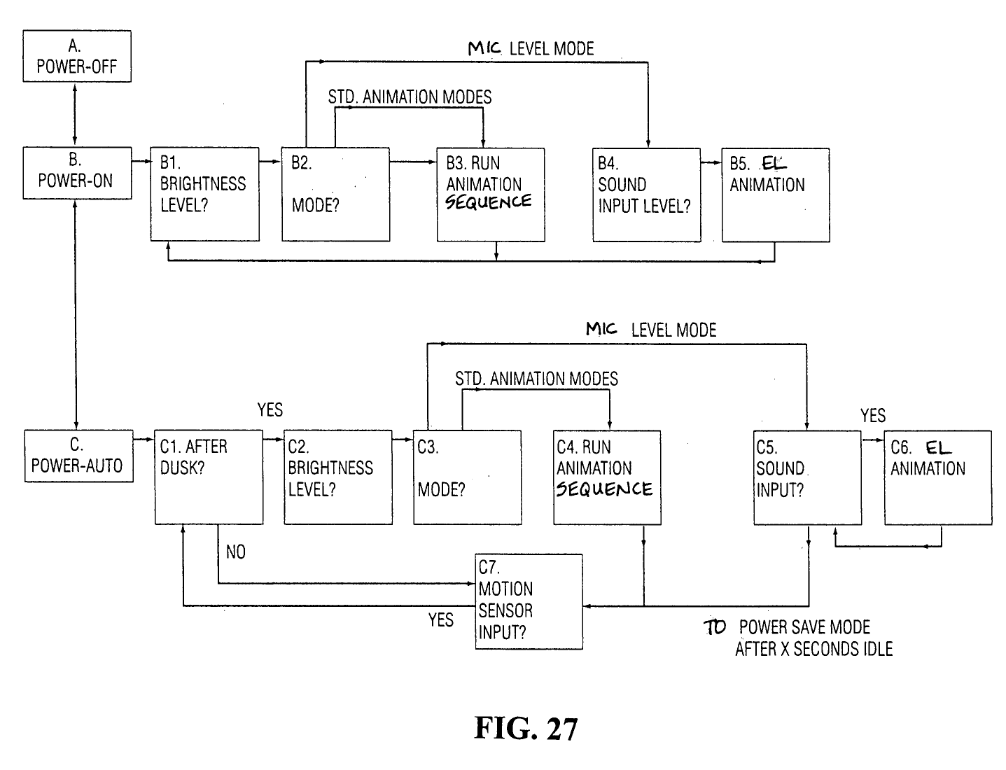

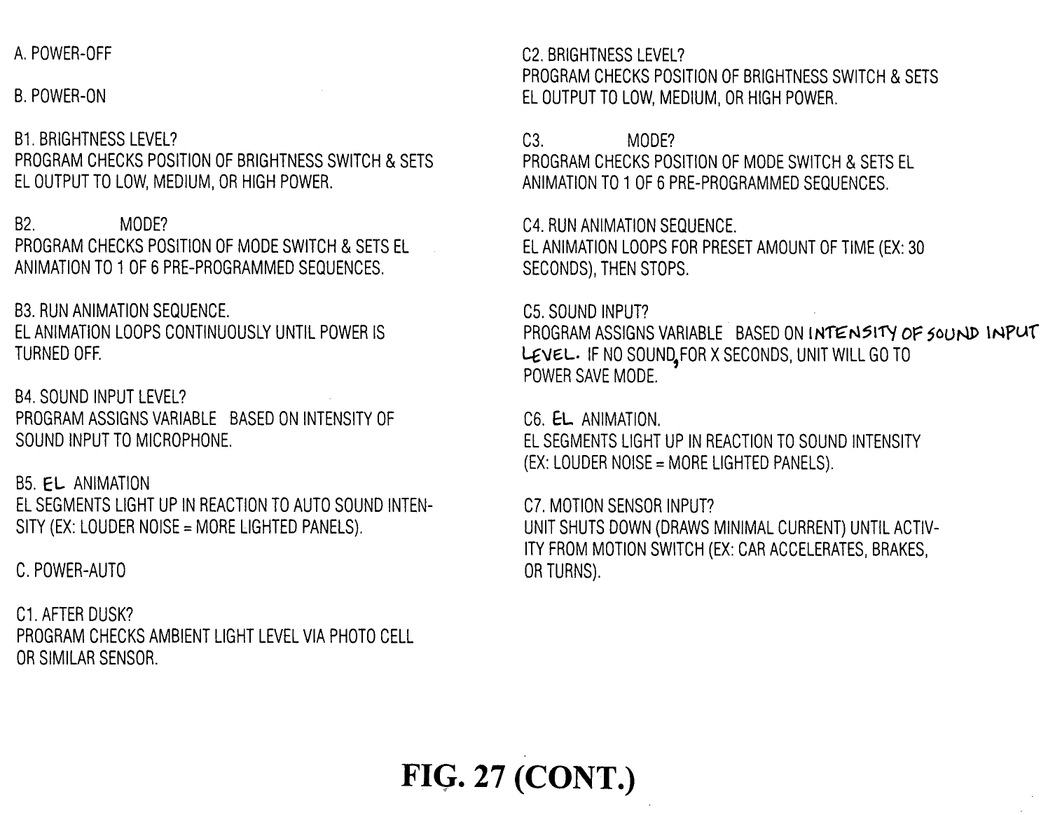

FIG. 27 shows another control scheme according to a different embodiment of this invention, wherein a noise level sensor, such as a microphone can be used to control the output at EL element 28. A user can select different animation sequences or graphical displays, for example as a function of either a mode from the microphone or a level of output from the microphone.

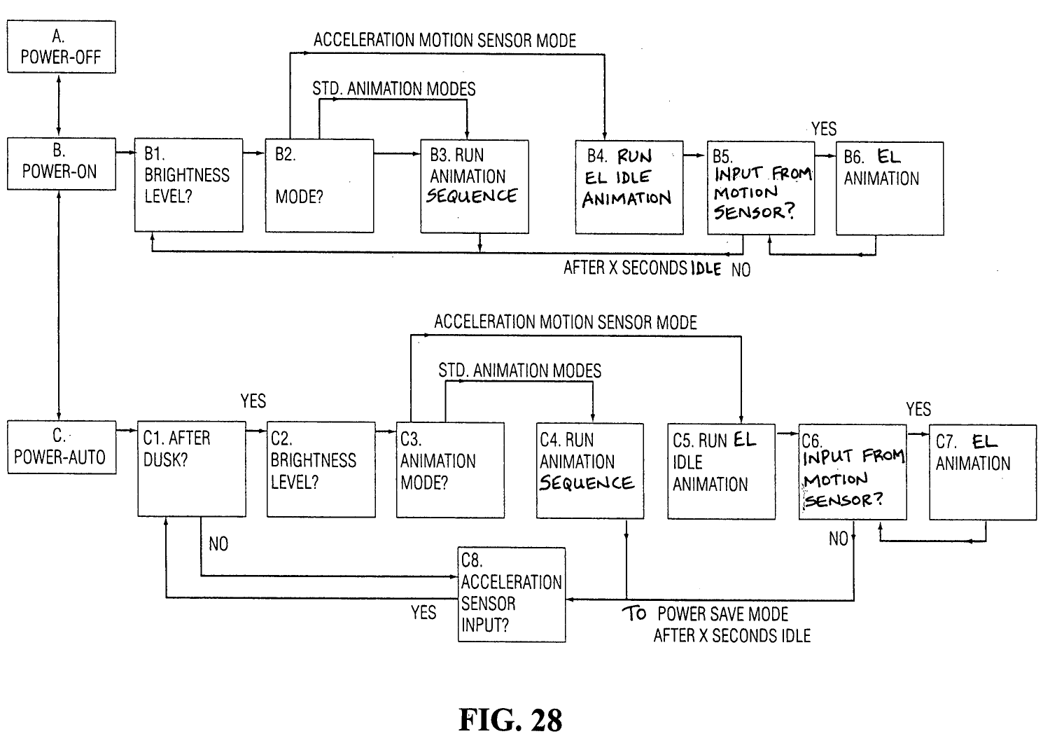

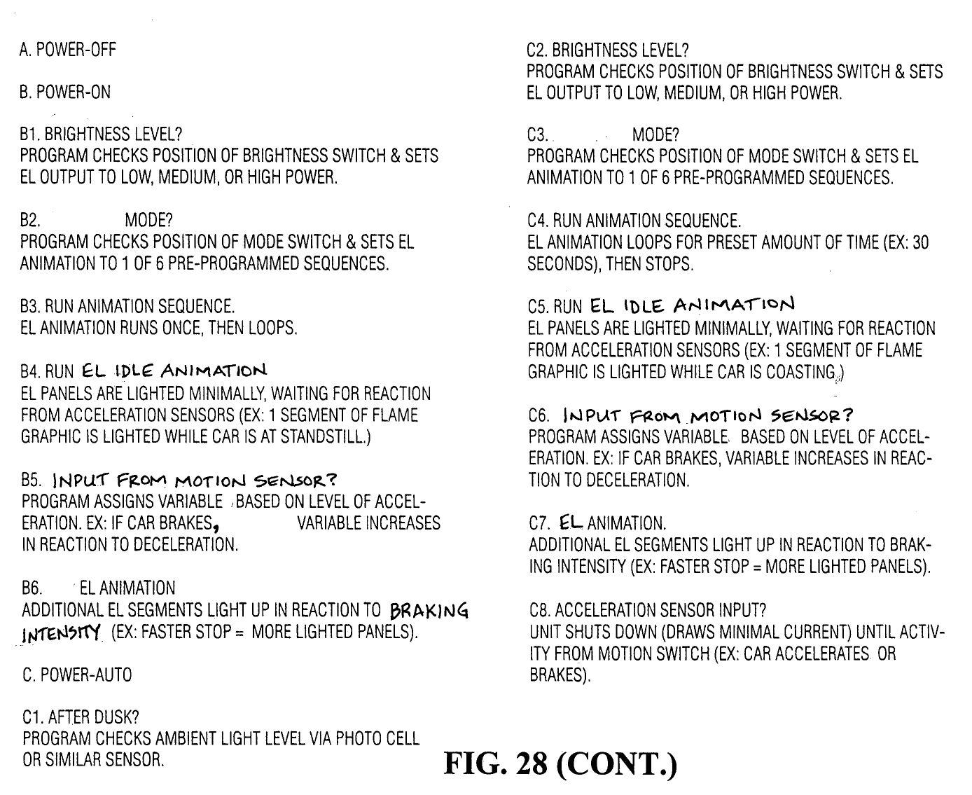

FIG. 28 shows a control scheme according to another embodiment of this invention, wherein an accelerometer is used to control the animation sequence or graphical display, for example as a function of a switch setting or a signal.

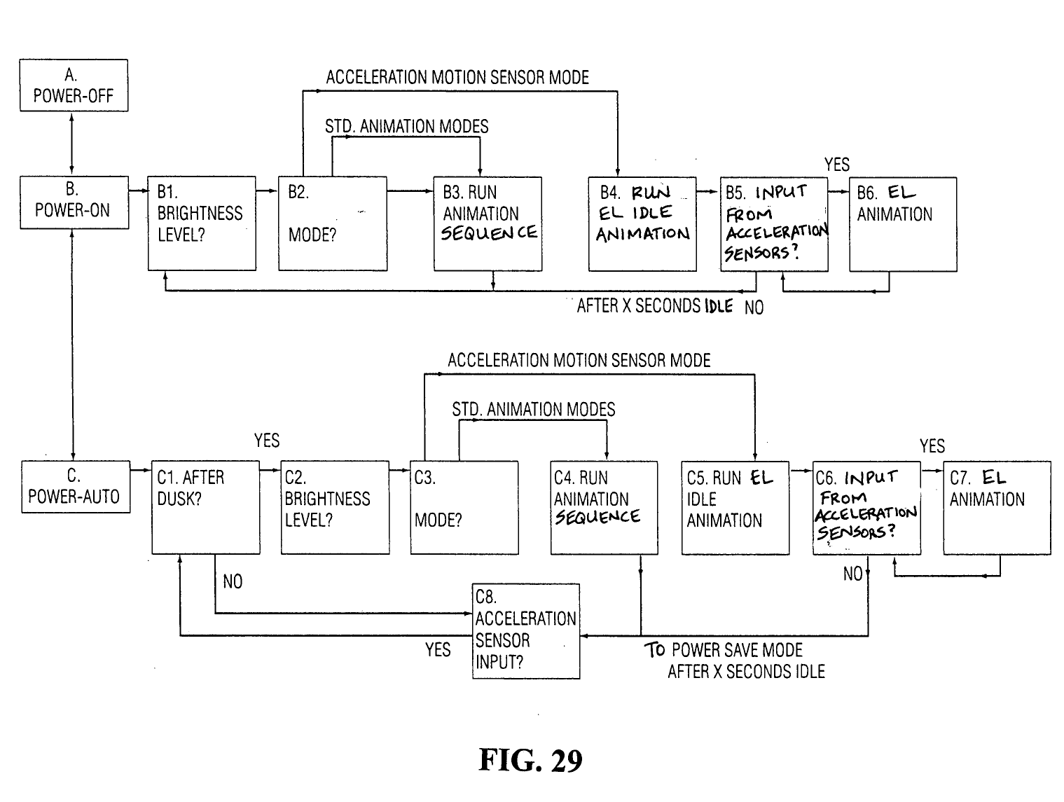

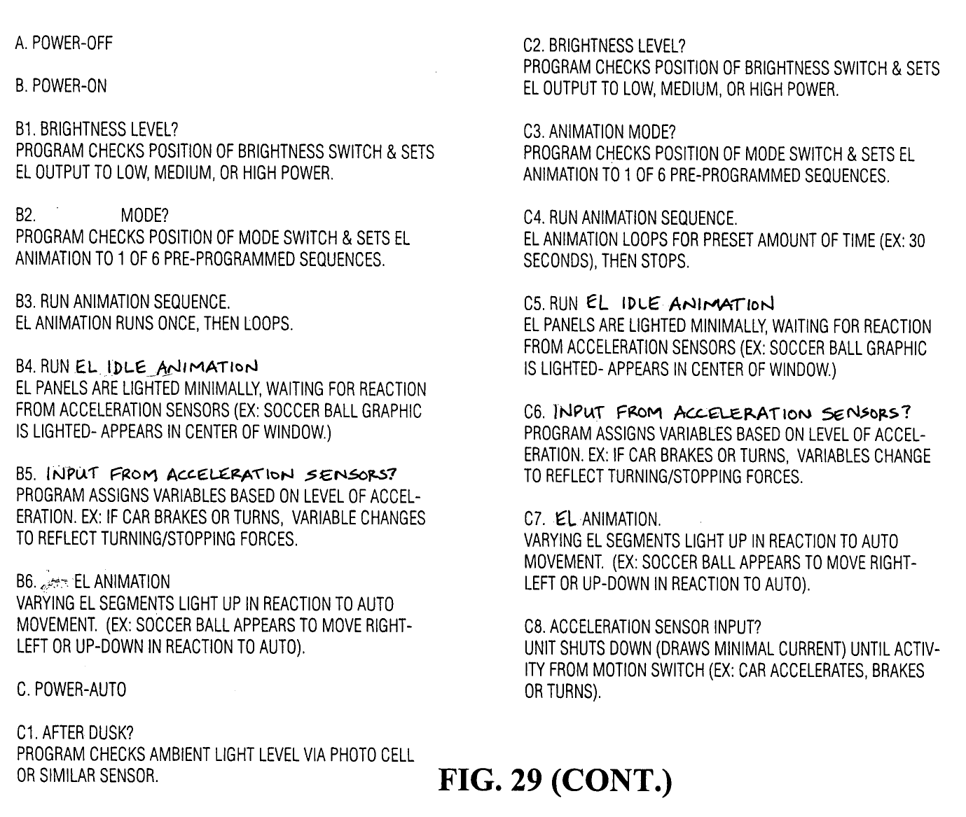

FIG. 29 shows a flow chart for a control scheme according to another embodiment of this invention, wherein a dual-acceleration sensor is used to deliver the input signal to control module 42. The dual-acceleration sensor can be used to sense breaking, turning and/or accelerating and thus deliver one or more input signals to control module 42, which can then emit one or more output signals to display a complex graphic, such as the left to right and/or up and down motion of a soccer ball, as previously discussed.

The different program steps identified in FIGS. 25-29 can be interchanged with each other. Additional computer steps can be used to convert any one or more sensed parameters into one or more output signals that can result in a graphic display, even a complex graphic display.

This invention is described in further detail in connection with the above embodiments or examples, which illustrate or simulate various aspects involved in the practice of this invention. It is to be understood that all changes that come within the spirit of this invention are desired to be protected and thus this invention is not to be construed as limited by any example.

I claim:

1. A light film apparatus comprising:
an illuminated graphics panel, at least one input source each communicating an input signal, and a control module receiving the input signal, calculating an output signal as a function of the input signal, and communicating the output signal with information to operate the illuminated graphics panel.

2. The light film apparatus according to claim 1, wherein the illuminated graphics panel comprises an electroluminescent display device.

3. The light film apparatus according to claim 2, wherein the electroluminescent display device displays at least one of a static graphic and a dynamic graphic.

4. The light film apparatus according to claim 2, wherein the electroluminescent display device has a plurality of segments and the control module communicates operational information to each of the segments.

5. The light film apparatus according to claim 1, wherein a lumen output level of the illuminated graphics panel is varied as a function of the input signal.

6. The light film apparatus according to claim 5, wherein the control module sets the lumen output level at or below a local required level.

7. The light film apparatus according to claim 6, wherein the at least one input source comprises at least one of a Global Positioning System device and a position identifying device.

8. The light film apparatus according to claim 1, wherein each input source comprises at least one of a light sensor, a dim sensor, a motion sensor, a vibration sensor, a mode sensor, a time sensor, an acceleration sensor, a velocity sensor, a direction sensor, a temperature sensor, a humidity sensor, a location sensor, a noise sensor, an optical sensor, a light switch, a dim switch, a motion switch, a vibration switch, a mode switch, a time switch, an acceleration switch, a velocity switch, a direction switch, a temperature switch, a humidity switch, a location switch, a noise switch, and an optical switch.

9. The light film apparatus according to claim 1, wherein the control module has a plurality of operating modes that can be selected at least one of manually and automatically.

10. The light film apparatus according to claim 1, wherein the illuminated graphics panel displays at least one graphic in response to the sensed signal.

11. The light film apparatus according to claim 1, further comprising a power supply connected to at least one of the control module and the illuminated graphics panel.

12. The light film apparatus according to claim 11, wherein the power supply comprises at least one of a solar panel and a battery.

13. The light film apparatus according to claim 11, wherein the control module manages a power rate at which the power supply delivers power to the illuminated graphics panel.

14. The light film apparatus according to claim 13, wherein the control module evaluates each input signal and calculates the output signal for setting the power rate at one of a zero value and at least a portion of a full power value.

15. The light film apparatus according to claim 11, wherein the power supply comprises a battery and the control module calculates the output signal for recharging the battery.

16. The light film apparatus according to claim 1, wherein the illuminated graphics panel is mounted with respect to a glass surface.

17. The light film apparatus according to claim 1, wherein the illuminated graphics panel is mounted with respect to a vehicle, and the input signal corresponds to at least one of a sensed driving parameter and a sensed environmental parameter.

18. The light film apparatus according to claim 1, wherein the input source comprises a dim switch operational to select one of a plurality of settings as the input signal.

19. The light film apparatus according to claim 18, wherein each of the settings corresponds to a different lumens output level of the illuminated graphics panel.

20. A method for operating a light film apparatus, comprising:
sensing at least one parameter and emitting a sensed signal to a control module;
the control module calculating an output signal as a function of the sensed signal; and
delivering the output signal to an illuminated graphics panel and displaying at least one graphic in response to the sensed signal.

21. The method according to claim 20, wherein the control module manages a power supply that delivers power to at the illuminated graphics panel.

22. The method according to claim 20, wherein the control module evaluates each sensed signal and emits the output signal with information to set a power rate at one of a zero value and at least a portion of a full power value.
